(19) United States
(12) Patent Application Publication
(10) Pub. No.: US 2026/0251410 A1
(43) Pub. Date: Aug. 27, 2026

(54) PARTITION MEMBER FOR TOTAL HEAT EXCHANGE ELEMENT, TOTAL HEAT EXCHANGE ELEMENT USING SAME, AND METHOD FOR PRODUCING PARTITION MEMBER FOR TOTAL HEAT EXCHANGE ELEMENT

(71) Applicant: Oji Holdings Corporation, Tokyo (JP)

(72) Inventors: Yoshiyuki YAMADA, Tokyo (JP); Kasumi KINOSHITA, Tokyo (JP); Kentaro TANAKA, Tokyo (JP); Hitoshi OKADA, Tokyo (JP); Kazuo YAMANE, Tokyo (JP); Kentaro MOROFUJI, Tokyo (JP)

(21) Appl. No.: 19/489,681

(22) PCT Filed: Jul. 4, 2024
(86) PCT No.: PCT/JP2024/024305

§ 371 Date: Dec. 3, 2025

(30) Foreign Application Priority Data
Jul. 6, 2023 (JP) 2023-111449
Jul. 6, 2023 (JP) 2023-111450

(51) Int. Cl. F28F 21/06; F28F 3/08

(52) U.S. Cl. CPC F28F 21/065; F28F 3/08; F28F 21/067; F28F 2245/04; F28F 2250/106; F28F 2255/00

(57) ABSTRACT

A partition member for a total heat exchanger with excellent heat exchange efficiency, and a method for producing a total heat exchanger. The partition member includes a hydrophobic porous substrate and a hydrophilic material in which an air permeability is 10,000 seconds or more and a moisture permeability under conditions of 20° C. and 65% RH is 2,500 g/m²·24 hours or more, and a method for producing the partition member. The method includes coating a solution containing polymer polysaccharide fine fibers with a fiber width of 1 to 1,000 nm onto a hydrophobic porous substrate and then drying.

### TECHNICAL FIELD

The present invention relates to a partition member for a total heat exchange element, a total heat exchange element using the same, and a method for producing a partition member for a total heat exchange element.

### BACKGROUND ART

Conventionally, heat exchange ventilation devices (total heat exchangers) that exchange heat between intake air and exhaust air during ventilation have been proposed as devices that can ventilate without impairing the effectiveness of cooling or heating. Total heat exchangers are widely used, and include a total heat exchange element which is constructed by stacking multiple partition members (liners) via spacing members to separate an intake air path that introduces outdoor air into a room from an exhaust air path that exhausts indoor air to the outside, and simultaneously exchanges sensible heat (temperature) and latent heat (humidity).

For example, in winter, outdoor air as supply air and indoor air as exhaust air are supplied into each flow path separated by spacing members. During this time, the supply air and the exhaust air exchange temperature and humidity via the partition member. The partition member, where heat exchange takes place, has moisture permeability, allowing water vapor to pass through but not air. The partition member also has gas barrier properties by isolating the supply air from the exhaust air. As a result, the supply air is heated and humidified before being supplied into the room, and the exhaust air is cooled and dehumidified before being discharged outdoors. As the partition member has both moisture permeability and gas barrier properties, ventilation through total heat exchange is achieved.

Such partition members must have both heat conductivity and moisture permeability, and therefore in many cases, paper containing natural pulp as a main component, such as glassine paper, is used (Patent Document 1).

In recent years, attempts have also been made to use cellulose nanofibers, which have gas barrier properties, as the partition members (Patent Document 2).

### PRIOR ART DOCUMENTS

### Patent Literature

Patent Document 1: Japanese Patent No. 4252892
Patent Document 2: Japanese Unexamined Patent Application, First Publication No. 2021-155865

### SUMMARY OF INVENTION

### Problem to be Solved by the Invention

In response to the demand for global warming mitigation and energy conservation, total heat exchange elements have been attracting attention. In order to further improve the heat exchange efficiency of the total heat exchange elements, it is believed that it would be effective to make the partition members thinner than ever before and to increase the number of stacked layers of the total heat exchange elements. However, this has been difficult to achieve with the partition members described in Patent Documents 1 and 2.

### Means for Solving the Problem

The present inventors conducted extensive research in order to provide a partition member for a total heat exchanger with excellent heat exchange efficiency, and, as a result, invented a new partition member that uses a hydrophobic porous substrate and a hydrophilic material.

In other words, the present invention relates to the following <1> to <15>.

<1> A partition member for a total heat exchange element comprising a hydrophobic porous substrate and a hydrophilic material, wherein an air permeability is 10,000 seconds or more and a moisture permeability under conditions of 20° C. and 65% RH is 2,500 g/m²·24 hours or more.

<2> A partition member for a total heat exchange element comprising a hydrophobic porous substrate and polymer polysaccharide fine fibers with a fiber width of 1 to 1,000 nm at least in pores of the hydrophobic porous substrate, and having an air permeability of 10,000 seconds or more and a moisture permeability under conditions of 20° C. and 65% RH of 2,500 g/m²·24 hours or more.

<3> The partition member for a total heat exchange element according to <2>, wherein the fine fibers are cellulose fine fibers.

<4> The partition member for a total heat exchange element according to <2> or <3>,
wherein an air permeability of the hydrophobic porous substrate is 1,000 seconds or less.

<5> The partition member for a total heat exchange element according to any one of <2> to <4>,
wherein a thickness of the hydrophobic porous substrate is 5 μm or more and 30 μm or less.

<6> The partition member for a total heat exchange element according to any one of <2> to <5>, wherein the fine fibers are adhered to the hydrophobic porous substrate.

<7> A partition member for a total heat exchange element comprising a hydrophobic porous substrate and a hydrophilic material,
wherein the hydrophilic material is adhered to the hydrophobic porous substrate,
wherein a thickness of the hydrophobic porous substrate is 5 μm or more and 30 μm or less,
wherein an adhesion amount of the hydrophilic material is 0.01 g/m² or more and 8 g/m² or less, and
wherein the partition member for a total heat exchange element has an areal density of 30 g/m² or less and an air permeability of 10,000 seconds or more.

<8> A total heat exchange element comprising a plurality of the partition members for a total heat exchange element according to any one of <1> to <7>, and spacing members arranged between the plurality of partition members for a total heat exchange element to maintain spacing between adjacent partition members for a total heat exchange element, wherein the total heat exchange element has a first air flow path formed by the partition member for a total heat exchange element and the spacing member provided thereon, and a second air flow path formed by the partition member for a total heat exchange element that forms the first air flow path and the spacing member provided below the partition member for a total heat exchange element that forms the first air flow path.

<9> A method for producing a partition member for a total heat exchange element,
wherein the method includes coating a coating solution containing polymer polysaccharide fine fibers with a fiber width of 1 to 1,000 nm to a hydrophobic porous substrate and then drying.

<10> The method for producing a partition member for a total heat exchange element according to
wherein the coating solution contains a surfactant.

<11> The method for producing a partition member for a total heat exchange element according to <9> or <10>,
wherein a coating amount of the fine fiber is 0.01 g/m² or more and 8 g/m² or less.

<12> The method for producing a partition member for a total heat exchange element according to any of <9> to <11>,
wherein the fine fiber is cellulose fine fiber.

<13> The method for producing a partition member for a total heat exchange element according to any one of <9> to <12>,
wherein an air permeability of the hydrophobic porous substrate is 1,000 seconds or less.

<14> The method for producing a partition member for a total heat exchange element according to any one of <9> to <13>,
wherein the hydrophobic porous substrate is subjected to surface hydrophilization treatment and then coated with the coating solution.

<15> A method for producing a partition member for a total heat exchange element having an areal density of 30 g/m² or less and an air permeability of 10,000 seconds or more, comprising coating a coating solution containing a hydrophilic material to at least one surface of a hydrophobic porous substrate having a thickness of 5 μm or more and 30 μm or less, so that an amount of the hydrophilic material adhered is 0.01 g/m² or more and 8 g/m² or less, and drying the coating solution.

### Effects of the Invention

The present invention provides a partition member for a total heat exchange element with excellent heat exchange efficiency, a total heat exchange element using the same, and a method for producing a partition member for a total heat exchange element. The present invention also provides a lightweight, extremely thin partition member for a total heat exchange element with high heat exchange efficiency, a total heat exchange element using the same, and a method for producing a partition member for a total heat exchange element.

### BRIEF DESCRIPTION OF DRAWINGS

FIG. 1 is a schematic diagram illustrating the structure of a total heat exchange element.

### DETAILED DESCRIPTION OF THE PREFERRED EMBODIMENTS

The partition member for a total heat exchange element is explained below. [Partition member for total heat exchange element]

### First Embodiment

The partition member for a total heat exchange element (hereinafter also referred to as partition member) of the present embodiment is a partition member for a total heat exchange element that includes a hydrophobic porous substrate (hereinafter also referred to as substrate) and a hydrophilic material, and has an air permeability of 10,000 seconds or more and a moisture permeability under conditions of 20° C. and 65% RH of 2,500 g/m²·24 Hr or more.

“Air permeability” is a value measured in accordance with the Oken air permeability method of JAPAN TAPPI Paper and Pulp Testing Method No. 5-2:2000. The preferred air permeability is 40,000 seconds or more. A higher air permeability value indicates better gas barrier properties.

The air permeability of the partition member for a heat exchange element in the present embodiment is 10,000 seconds or more. The preferred air permeability is 40,000 seconds or more.

“Moisture permeability” is a value measured in accordance with JIS Z 0208:1976. The preferable moisture permeability is 3000 g/m²·24 Hr or more. A higher moisture permeability value indicates better heat exchange efficiency.

### (Hydrophobic Porous Substrate)

The substrate used is not particularly limited, but a thickness of 5 μm to 30 μm is preferred, with 10 to 25 μm being even more preferable. A thickness above the lower limit maintains the strength of the partition member, while a thickness below the upper limit increases heat exchange efficiency of sensible heat (temperature) and enables weight reduction.

The thickness is measured in accordance with JIS P 8118:2014.

The areal density of the substrate is preferably 29 g/m² or less. It is preferably 25 g/m² or less, and more preferably 20 g/m² or less. There is no particular limit to the lower limit, and it is 2 g/m² or more, and more preferably 5 g/m² or more.

By keeping the areal density of the substrate below the upper limit, sufficient pores and voids are secured to ensure the necessary moisture permeability, and by setting it above the lower limit, the strength required as a partition member is maintained.

The areal density of the hydrophobic porous substrate is a value measured as the weight per unit area.

The base material is hydrophobic, which allows for weight reduction. For example, if hydrophilic paper is used, a large amount of polymer polysaccharide fine fibers must be coated to enhance gas barrier properties, making weight reduction difficult.

The air permeability of the substrate is preferably 1,000 seconds or less, and more preferably 500 seconds or less. If the substrate is porous and its air permeability is 1000 seconds or less, heat exchange of latent heat (humidity) will occur smoothly. There is no particular lower limit for the air permeability, but it is 10 seconds or more, preferably seconds or more, and more preferably 50 seconds or more.

For example, films and nonwoven fabrics made of thermoplastic resins such as polyolefins and polyesters, with an air permeability of 1,000 seconds or less, preferably 500 seconds or less, can be used.

By adhering a hydrophilic material to the substrate, it is possible to increase air permeability without significantly impairing moisture permeability, thereby improving the gas barrier properties of the partition member. When the amount of hydrophilic material adhered is 0.01 g/m² or more and 8 g/m² or less, the pores in the substrate can be sealed with the hydrophilic material, and a decrease in moisture permeability can be suppressed. As the amount of hydrophilic material adhered increases, gas barrier properties are excellent, but moisture permeability tends to be impaired, so an adhesion amount of 5 g/m² or less is preferred. On the other hand, as the amount of hydrophilic material adhered decreases, sufficient gas barrier properties tend not to be obtained, so an adhesion amount of 0.03 g/m² or more is preferred.

The amount of hydrophilic material adhered can also be referred to as the coating amount of hydrophilic material, as described in detail below.

### (Hydrophilic Material)

There are no particular limitations on hydrophilic materials, as long as they adhere to a substrate to form a film and exhibit gas barrier properties.

Examples of the hydrophilic material include polymer polysaccharides such as cellulose, chitin, chitosan, and carboxymethyl cellulose, as well as their derivatives; polyvinyl alcohol and its derivatives; and ethylene-vinyl alcohol copolymers and their derivatives.

For example, polymer polysaccharide has a molecular structure with many hydroxyl groups (—OH), which means it has moisture absorption properties and the film it forms has gas barrier properties. Polyvinyl alcohol also has a molecular structure with many hydroxyl groups (—OH), which makes it an excellent film-forming material. Of these, fibrous materials are preferred, with fine fiber polymer polysaccharide being more preferred, and cellulose fine fiber being especially preferred.

Cellulose fine fiber is preferred as it forms a dense structure when adhered by coating and drying, making it an excellent gas barrier material.

### Second Embodiment

The partition member of the present embodiment contains a hydrophobic porous substrate and polymer polysaccharide fine fibers with a fiber width of 1 to 1,000 nm in at least the pore portions of the hydrophobic porous substrate, and has an air permeability of 10,000 seconds or more and a moisture permeability of 2,500 g/m²·24 Hr or more.

In order to enhance gas barrier properties, the partition member for a total heat exchange element of the present embodiment must contain polymer polysaccharide fine fibers with a fiber width of 1 to 1,000 nm in at least the pore portions of the hydrophobic porous substrate, and must have an air permeability of 10,000 seconds or more. The preferred air permeability is 40,000 seconds or more.

The air permeability of the partition member can be measured using the same method as described for the partition member of the first embodiment above.

Furthermore, the partition member for a total heat exchange element in the present embodiment must have a moisture permeability of 2,500 g/m²·24 hr or more at a temperature of 20° C. and a relative humidity of 65%. A higher moisture permeability value indicates better heat exchange efficiency. A preferred moisture permeability is 2800 g/m²·24 hr or more, and a more preferred moisture permeability is 3000 g/m²·24 hr in or more.

The moisture permeability of the partition member can be measured using the same measurement method as described for the partition member of the first embodiment above.

### (Hydrophobic Porous Substrate)

The hydrophobic porous substrate of the partition member in the present embodiment can be the same as the substrate used in the first embodiment.

### (Polymer Polysaccharide Fine Fibers)

In the present embodiment, the partition member is configured such that polymer polysaccharide fine fibers with a fiber width of 1 to 1,000 nm adhere to at least the pores of the hydrophobic porous substrate to satisfy both the air permeability and moisture permeability requirements. The amount of polymer polysaccharide fine fibers adhering to the hydrophobic porous substrate is not particularly limited, but is generally between 0.01 g/m² and 8 g/m², preferably between 0.03 g/m² and 3 g/m², and more preferably between 0.03 g/m² and 2 g/m². By adhering to the substrate, the pores in the substrate can be blocked with the hydrophilic material and a decrease in moisture permeability can be suppressed. When the adhesion amount of the polymer polysaccharide fine fiber is large, the gas barrier property is excellent, but moisture permeability tends to be impaired, so the adhesion amount is preferably 8 g/m² or less. On the other hand, when the adhesion amount of the polymer polysaccharide fine fiber is small, the pores are not sufficiently covered and the gas barrier property tends to be insufficient, so the adhesion amount is preferably 0.01 g/m² or more.

The polymer polysaccharide fine fiber is not particularly limited as long as it is a water-insoluble material that forms a film by adhering to a hydrophobic porous substrate and that exhibits gas barrier properties. Examples of the polymer polysaccharide fine fiber include polymer polysaccharides such as cellulose, chitin, and chitosan. Polymer polysaccharides have a molecular structure with numerous hydroxyl groups (—OH), which allows them to absorb moisture, and the film they form has gas barrier properties. Among these, the use of fine fibers with a fiber width of 1 to 1,000 nm can enhance air permeability and moisture permeability. From the perspective of gas barrier properties, a fiber width of 1 to 500 nm is preferred, and a fiber width of 1 to 100 nm is more preferred. Cellulose fine fiber is particularly preferred for its excellent gas barrier properties, as it forms a dense structure when adhered by coating and drying.

As the polymer polysaccharide fine fiber, it is preferable to use cellulose fine fiber with a fiber width of 1 to 1,000 nm. Among these, from the viewpoint of gas barrier properties, a fiber width of 1 to 500 nm is preferred, a fiber width of 1 to 100 nm is more preferred, a fiber width of 1 to 10 nm is even more preferred, and a fiber width of 1 to 10 nm is particularly preferred. By making the fiber width of the cellulose fine fiber 1 nm or more, dissolution of the cellulose molecules in water is suppressed, and the effect of improving the air permeability and the moisture permeability by the cellulose fine fiber is easily achieved.

The fiber width of polymer polysaccharide fine fibers is measured using electron microscopy as follows.

First, an aqueous suspension of cellulose fibers with a concentration of 0.05% to 0.1% by mass is prepared, and this suspension is cast onto a hydrophilically treated carbon film-coated grid to prepare a sample for TEM observation. If the sample contains wide fibers, an SEM image of the surface cast onto glass can also be observed.

Next, the electron microscope image is observed at a magnification of 1,000×, 5,000×, 10,000×, or 50,000×, depending on the width of the fibers to be observed. However, the sample, observation conditions, and magnification should be adjusted to meet the following conditions.

(1) Draw a line X anywhere within the observed image, and 20 or more fibers intersect this line X.

(2) Draw a line Y that intersects the line X perpendicularly within the same image, and 20 or more fibers intersect this line Y.

For observed images that satisfy the above conditions, visually read the widths of the fibers that intersect with lines X and Y. In this way, obtain three or more sets of observed images of at least the surface portions that do not overlap each other. Next, read the widths of the fibers that intersect with lines X and Y for each image. In this way, read the widths of at least 20×2×3=120 fibers. The average fiber width is the average value of the fiber widths of the polymer polysaccharide fine fibers that were read.

There are no particular limitations on the fiber length of the polymer polysaccharide fine fibers, but it is preferably 0.1 μm or longer, and preferably 1,000 μm or shorter, more preferably 800 μm or shorter, and even more preferably 600 μm or shorter. By keeping the fiber length of the polymer polysaccharide fine fibers within the above range, destruction of the crystalline regions of the polymer polysaccharide fine fibers can be suppressed. It also becomes possible to set the slurry viscosity of the cellulose fine fiber within an appropriate range, facilitating the formation of a fiber layer.

The fiber length of the cellulose fine fiber can be determined by image analysis using, for example, TEM, SEM, or AFM.

The axial ratio (fiber length/fiber width) of the polymer polysaccharide fine fiber is not particularly limited, but is preferably at least 20, more preferably at least 50, and is preferably at most 10,000, more preferably at most 1,000. By keeping the axial ratio within this range, a slurry viscosity suitable for forming a fiber layer can be obtained.

In the partition member of the present embodiment, it is preferable that at least one type of group selected from ionic and nonionic groups be introduced into the polymer polysaccharide fine fiber. Furthermore, the ionic and nonionic groups are preferably hydrophilic groups. From the viewpoint of improving the dispersibility of the fiber in the dispersion medium and increasing the fibrillation efficiency in the fibrillation treatment, it is more preferable that the polymer polysaccharide fine fiber have an ionic group. The ionic group may include either or both of an anionic group and a cationic group. In the present embodiment, it is particularly preferable that the ionic group be an anionic group. The anionic group is preferably at least one selected from a phosphate group or a group derived from a phosphate group, a phosphite group or a group derived from a phosphite group, a carboxy group or a group derived from a carboxy group, and a sulfonic acid group or a group derived from a sulfonic acid group.

The partition member for a total heat exchange element of the present embodiment contains the hydrophobic porous substrate and the polymer polysaccharide fine fibers with a fiber width of 1 to 1,000 nm in at least the pore portions of the hydrophobic porous substrate, and has an air permeability of 10,000 seconds or more and a moisture permeability of 2,500 g/m²·24 hours or more. The partition member of the present embodiment is a partition member for a total heat exchanger that has high air permeability and moisture permeability, that has excellent carbon dioxide barrier properties, and that is resistant to a decrease in mechanical strength even if condensation occurs. In addition, its lightweight construction allows for an increase in the number of stacked layers of the total heat exchange element.

### Third Embodiment

The partition member of the present embodiment is a partition member for a total heat exchange element comprising a hydrophobic porous substrate and a hydrophilic material. The thickness of the hydrophobic porous substrate is 5 μm to 30 μm, the adhesion amount of the hydrophilic material is 0.01 g/m² to 8 g/m², the areal density of the partition member for a total heat exchange element is 30 g/m² or less, and the air permeability is 10,000 seconds or more.

The areal density of the partition member is preferably 30 g/m² or less, and more preferably 26 g/m² or less. There is no particular limitation on the lower limit, and it is 2 g/m² or more, and more preferably 5 g/m² or more.

Setting the areal density of the partition member at or below the upper limit ensures sufficient pores and voids and the necessary moisture permeability, while setting it at or above the lower limit maintains the strength of the partition member.

The areal density of the partition member is a value measured using the same method as the method for measuring the areal density of the hydrophobic porous substrate described in the first embodiment above.

The “air permeability” of the partition member is a value measured by the same method as the air permeability measurement method described in the first embodiment above. The preferred air permeability is 40,000 seconds or more. A larger air permeability value indicates better gas barrier properties.

### (Hydrophobic Porous Substrate)

The substrate used is not particularly limited as long as it has a thickness of 5 μm or more and 30 μm or less. A preferred thickness is 10 to 25 μm. A thickness above the lower limit maintains the strength of the partition member, while a thickness below the upper limit increases the heat exchange efficiency of sensible heat (temperature) and enables weight reduction.

The thickness of the substrate can be measured using the same method as described for the partition member in the first embodiment above.

In order to make the areal density of the partition member for a total heat exchange element 30 g/m² or less, the areal density of the hydrophobic porous substrate is preferably 29 g/m² or less, more preferably 25 g/m² or less, and even more preferably 20 g/m² or less. There is no particular limitation on the lower limit, but it is 2 g/m² or more, more preferably 5 g/m² or more.

By adopting a configuration in which the thickness of the hydrophobic porous substrate is 5 μm to 30 μm, the adhesion amount of the hydrophilic material is 0.01 g/m² to 8 g/m², and the partition member for a total heat exchange element has an areal density of 30 g/m² or less and an air permeability of 10,000 seconds or more, an extremely thin partition member for a total heat exchanger is obtained that has high air permeability and moisture permeability and excellent carbon dioxide barrier properties. In addition, because it is lightweight, it is possible to increase the number of stacked layers of the total heat exchange element.

### (Hydrophilic Material)

In the present embodiment, the partition member can use the same hydrophilic material as used in the first and second embodiments.

### (Moisture Absorbent)

The partition member of the present invention has a small adhesion amount of hydrophilic material (e.g., polymer polysaccharide fine fiber), so latent heat (humidity) heat exchange occurs without the addition of a moisture absorbent. However, moisture absorbents may be added to further enhance moisture permeability. Examples of the moisture absorbents include inorganic acid salts, organic acid salts, polyhydric alcohols, and ureas. Examples of inorganic acid salts include lithium chloride, calcium chloride, and magnesium chloride. Examples of organic acid salts include sodium lactate, calcium lactate, and sodium pyrrolidone carboxylate. Examples of polyhydric alcohols include glycerin, ethylene glycol, tricthylene glycol, and polyglycerin. Examples of ureas include urea and hydroxyethyl urea.

The producing method for a partition member is described below.

### [Method for Producing Partition Member]

### First Embodiment

In the producing method for a partition member for a total heat exchange element of the present embodiment, a coating solution containing polymer polysaccharide fine fibers with a fiber width of 1 to 1,000 nm is coated to at least one surface of a hydrophobic porous substrate, followed by drying.

Details of the hydrophobic porous substrate and polymer polysaccharide fine fiber are as described above.

The polymer polysaccharide fine fiber can be adhered by coating. For example, a coating solution containing polymer polysaccharide fine fiber can be coated to the hydrophobic porous substrate and dried to form an adherent film.

A known coating machine can be used for the coating method, and although there are no particular limitations, blade coaters, bar coaters, curtain coaters, die coaters, air knife coaters, and roll coaters can be used. Of these, blade coaters and bar coaters are preferred because the pressing force of the blade or bar during coating allows the coating solution to penetrate into the pores of the porous substrate. For drying, a dryer attached to the coating machine can be used. The drying temperature should preferably be a surface temperature of 90° C. or less, and more preferably 80° C. or less. Drying at high temperatures may cause the coating solution to bump.

The adhesion amount of the polymer polysaccharide fine fibers is preferably 0.01 g/m² or more and 8 g/m² or less. When the adhesion amount of the polymer polysaccharide fine fibers is within the above range, a uniform coating film can be formed, the pores of the substrate can be blocked with the hydrophilic material, and a decrease in moisture permeability can be suppressed. When the adhesion amount of the polymer polysaccharide fine fibers is large, the gas barrier property is excellent but moisture permeability tends to be impaired, so the adhesion amount is more preferably 3 g/m² or less. On the other hand, when the adhesion amount of the polymer polysaccharide fine fibers is small, sufficient gas barrier property tends to be insufficient, so the adhesion amount is more preferably 0.03 g/m² or more. Applying the polymer polysaccharide fine fibers by coating is preferable because the polymer polysaccharide fine fibers penetrate not only the surface of the hydrophobic porous substrate but also into the pores, thereby enhancing moisture permeability.

As explained above, since a coating solution containing a hydrophilic material is coated to a hydrophobic porous substrate, the hydrophilic material contained in the coating solution adheres to the hydrophobic porous substrate. Therefore, the coating amount of the hydrophilic material contained in the coating solution can be rephrased as the adhesion amount of the hydrophilic material.

When coating the coating solution containing polymer polysaccharide fine fibers to the hydrophobic porous substrate, if the hydrophobic porous substrate repels the coating solution, it is recommended to add a surfactant, wetting agent, leveling agent, and the like to the coating solution, or to subject the hydrophobic porous substrate to surface hydrophilization treatment such as corona discharge treatment in advance, or to use a combination of these. If repelling occurs during coating, it tends to be difficult to obtain a partition member for a total heat exchange element with an air permeability of 10,000 seconds or more. It is preferable to use surfactants, wetting agents, leveling agents, etc. that have reduced foaming properties.

In addition, auxiliary agents such as preservatives, mildew inhibitors, flame retardants, viscosity adjusters, pH adjusters, colorants, storage improvers, and polymer resins may be added to the coating solution within a range that does not impair the effects of the present invention.

When coating a coating solution containing the polymer polysaccharide fine fibers, the adhesion amount should be adjusted so that the resulting partition member for a total heat exchange element has an air permeability of 10,000 seconds or more. It is also preferable to adjust the adhesion amount so that the partition member for a total heat exchange element has a moisture permeability of 2,500 g/m²·24 hours or more.

### Second Embodiment

In the present embodiment, a method for producing a partition member for a total heat exchange element includes coating a coating solution containing a hydrophilic material to at least one surface of a hydrophobic porous substrate having a thickness of 5 μm to 30 μm, with the adhesion amount of the hydrophilic material being 0.01 g/m² to 8 g/m², and then drying the coating solution to produce a partition member for a total heat exchange element having an areal density of 30 g/m² or less and an air permeability of 10,000 seconds or more.

Details of the hydrophobic porous substrate and polymer polysaccharide fine fiber are as described above.

By setting the adhesion amount of the polymer polysaccharide fine fibers to 0.01 g/m² or more and 8 g/m² or less, a uniform coating film can be formed, as described above, allowing the pores of the substrate to be sealed with the hydrophilic material and suppressing a decrease in moisture permeability. A large adhesion amount of the polymer polysaccharide fine fibers improves gas barrier properties but tends to impair moisture permeability, so an adhesion amount of 3 g/m² or less is more preferable. On the other hand, a small adhesion amount of the polymer polysaccharide fine fibers tends to result in insufficient gas barrier properties, so an adhesion amount of 0.03 g/m² or more is more preferable. Coating polymer polysaccharide fine fibers by coating is preferable because it enhances moisture permeability, possibly because the polymer polysaccharide fine fibers penetrate not only the surface of the hydrophobic porous substrate but also into the pores.

By setting the adhesion amount of the polymer polysaccharide fine fibers to 0.01 g/m² or more and 8 g/m² or less, it is possible to easily obtain a partition member for a total heat exchange element with an areal density of 30 g/m² or less and an air permeability of 10,000 seconds or more.

The total heat exchange element is described below.

### [Total Heat Exchange Element]

The total heat exchange element in the present embodiment is a total heat exchange element that uses the partition member for a heat exchange element of the present invention.

In other words, the total heat exchange element of the present embodiment includes multiple partition members for a total heat exchange element, as well as spacing members arranged between the partition members for a total heat exchange element to maintain the spacing between adjacent partition members for a total heat exchange elements, and has a first air flow path formed by the partition member for a total heat exchange element and the spacing member provided above the partition member, and a second air flow path formed by the partition member for a total heat exchange element that form the first air flow path and the spacing member provided below the partition member for a total heat exchange element that form the first air flow path.

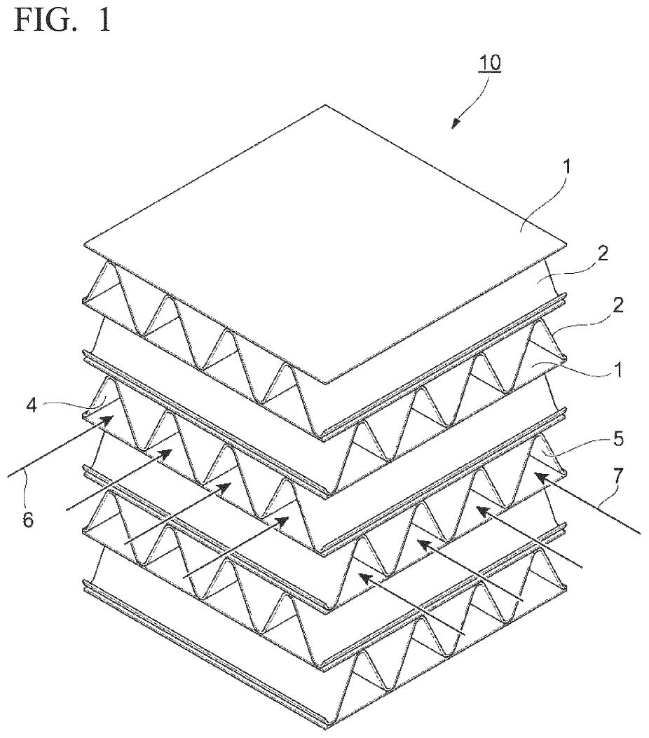

The total heat exchange element will be described below using FIG. 1, but the present invention is not limited to the total heat exchange element with the structure shown in FIG. 1.

FIG. 1 is a schematic diagram illustrating the structure of a total heat exchange element 10. As shown in FIG. 1, the total heat exchange element 10 includes a plurality of partition members 1 and a plurality of spacing members 2 that form air flow paths between the plurality of partition members 1 and that maintain the spacing between the partition members 1. The partition members 1 are flat plates that are shaped like squares or diamonds, and the spacing members 2 maintain the spacing between the partition members 1 and are, for example, corrugated plates with waveforms such as sawtooth or sinusoidal waves whose projected planar shape matches the shape of the partition members 1. The spacing members 2 are shaped, for example, like the core of cardboard and are formed by corrugating.

### [Spacing Member]

The spacing member is not particularly limited as long as it maintains the spacing between partition members. By maintaining the spacing between partition members, the spacing member forms air flow paths between multiple partition members. The spacing members are not limited to corrugated materials such as paper substrates, films, and nonwoven fabrics, but can also be resin ribs. Of these, paper substrates are preferred. Because paper substrates have the ability to regulate moisture, they can compensate for the reduced humidity regulation of the partition members using hydrophobic porous substrates.

The wavy ridges and valleys of the spacing member 2 are joined to the partition member 1 with an adhesive or the like. The spacing member 2 is joined to one surface of the partition member 1 with the wavy ridges extending in a first direction (for example, a vertical direction), and to the other surface of the spacing member 2 with the wavy ridges extending in a second direction (for example, a horizontal direction).

In other words, for two adjacent spacing members 2 sandwiching the partition member 1, the spacing members 2 are stacked alternately with the partition member 1 in between so that the direction of the wavy ridges of the spacing member 2 joined to one surface of the partition member 2, that is, the first air flow path, is perpendicular to the direction of the wavy ridges of the spacing member 2 joined to the other surface of the partition member 2, that is, the second air flow path.

Between the spacing member 2 whose wave-shaped ridge lines are oriented in the first direction (e.g., the vertical direction) and the partition members 1 on both sides of the spacing member 2, a plurality of first air flow paths 4 are formed along the first direction. Furthermore, between the spacing member 2 whose wave-shaped ridge lines are oriented in the second direction (e.g., the horizontal direction) and the partition members 1 on both sides of the spacing member 2, a plurality of second air flow paths 5 are formed along the second direction. Note that an arrow 6 in FIG. 1 indicates the direction of air flow in the first air flow path 4, and an arrow 7 in FIG. 1 indicates the direction of air flow in the second air flow path 5.

The spacing members 2 whose wave-shaped ridge lines are oriented in the first direction and the spacing members 2 whose wave-shaped ridge lines are oriented in the second direction are alternately stacked with the partition member 1 in between so that the ridge directions are perpendicular to each other. As a result, the first air flow path 4 and the second air flow path 5 are also formed so that their extension directions are perpendicular to each other. For example, supply air flows through the first air flow path 4, and exhaust air flows through the second air flow path 5, with heat exchange occurring between the supply air and the exhaust air via the partition member 1 and the spacing member 2.

In the example shown in FIG. 1, the spacing members 2 are arranged so that the first air flow path and the second air flow path are perpendicular to each other. However, the spacing members 2 do not necessarily have to be arranged so that the first air flow path and the second air flow path are perpendicular to each other; they may be oriented in different directions, such as facing each other.

The partition member and the spacing member can be joined by known methods such as a method using an adhesive or a thermal bonding method without using an adhesive. Among these, a method using an adhesive is preferred because it can firmly bond the spacing member and the partition member. Known adhesives such as polyvinyl alcohol adhesives and ethylene vinyl acetate adhesives can be used as the adhesive.

### EXAMPLES

The features of the present invention will be explained in more detail below with reference to examples and comparative examples. The materials, amounts used, ratios, treatment contents, treatment procedures, and the like shown in the following examples can be changed as appropriate without departing from the concept of the present invention. Therefore, the scope of the present invention should not be construed as being limited by the specific examples shown below.

### <Producing Substrate>

Substrate A: A 20 μm-thick polyethylene film (product name: SW320H, manufactured by Shenzhen Senior Technology Material Co., Ltd.) was prepared as a hydrophobic porous substrate. The areal density was 10.0 g/m².

Substrate B: A 16 μm-thick polypropylene film (product name: SD216101+, manufactured by Shenzhen Senior Technology Material Co., Ltd.) was prepared as a hydrophobic porous substrate. The areal density was 9.4 g/m².

### <Producing Cellulose Fine Fiber A>

### (Phosphate Group Introduction Process)

The raw pulp used was softwood kraft pulp manufactured by Oji Paper Co., Ltd. (93% solids, 210 g/m² sheet, disintegrated, with a Canadian Standard Freeness (CSF) of 690 ml measured in accordance with JIS P 8121:2012).

This raw pulp was subjected to a phosphate treatment as follows.

First, a mixed aqueous solution of ammonium dihydrogen phosphate and urea was added to the raw pulp to adjust the ratio to 45 parts ammonium dihydrogen phosphate, 120 parts urea, and 150 parts water per 100 parts raw pulp (bone dry weight). This resulted in a chemical-impregnated pulp. The resulting chemical-impregnated pulp was then heated in a hot air dryer at 165° C. for 200 seconds to introduce phosphate groups into the cellulose in the pulp, yielding a phosphorylated pulp.

### (Washing Process)

The resulting phosphorylated pulp was then washed.

The washing process was carried out by pouring 10 L of ion-exchanged water over 100 g (bone dry weight) of phosphorylated pulp, stirring to uniformly disperse the pulp, and then repeatedly filtering and dehydrating the pulp. The washing process ended when the electrical conductivity of the filtrate reached 100 μS/cm or less.

### (Alkaline Treatment Process)

The washed phosphorylated pulp was then subjected to an alkali treatment (neutralization treatment) as follows.

First, the washed phosphorylated pulp was diluted with 10 L of ion-exchanged water, and then a IN aqueous solution of sodium hydroxide was added little by little while stirring to obtain a phosphorylated pulp slurry with a pH of 12 to 13. The phosphorylated pulp slurry was then dewatered to obtain phosphorylated pulp that had been subjected to an alkali treatment (neutralization treatment).

The alkali-treated phosphorylated pulp was then subjected to the washing treatment described above.

The infrared absorption spectrum of the alkali-treated phosphorylated pulp obtained was measured using FT-IR. As a result, absorption due to phosphate groups was observed around 1,230 cm⁻¹, confirming that phosphate groups had been added to the pulp.

The resulting phosphorylated pulp was also analyzed using an X-ray diffractometer. Peaks typical of cellulose type I crystals were confirmed at two positions, near 2θ=14° to 17° and near 2θ=22° to 23°, confirming the presence of cellulose type I crystals.

### (Fibrillation Process)

Ion-exchange water was added to the phosphorylated pulp obtained through the alkali treatment process to prepare a slurry with a solid concentration of 2% by mass. This slurry was processed three times at a pressure of 200 MPa using a wet atomizer (Starburst, manufactured by Sugino Machine Co., Ltd.) to obtain a cellulose fine fiber dispersion containing cellulose fine fiber A. X-ray diffraction confirmed that this cellulose fine fiber A maintained cellulose type I crystal structure. Furthermore, the fiber width of cellulose fine fiber A was measured using a transmission electron microscope and found to be 3-5 nm.

### <Producing Cellulose Fine Fiber B>

### (Fibrillation Process)

Ion-exchange water was added to the phosphorylated pulp obtained through the alkali treatment process to prepare a slurry with a solids concentration of 2% by mass. This slurry was processed once in a wet pulverizer (Starburst, manufactured by Sugino Machine Co., Ltd.) at a pressure of 200 MPa to obtain a cellulose fine fiber dispersion containing cellulose fine fiber B. X-ray diffraction confirmed that this cellulose fine fiber B maintained cellulose type I crystal structure. Furthermore, measurement of the fiber width of cellulose fine fiber B using a transmission electron microscope confirmed fibers with a fiber width of 3 to 500 nm.

### Example 1-1

### <Producing Partition Member for Total Heat Exchange Element>

A coating solution was prepared by adding 0.8 parts of a polyether surfactant (product name: SN Wet 985, manufactured by San Nopco, 76% aqueous dispersion) to 99.2 parts of a 0.4% aqueous dispersion of the cellulose fine fiber A obtained above.

After corona discharge treatment was performed on one side of the substrate A, the coating solution was coated using a Mayer bar such that an adhesion amount (coating amount) of the cellulose fine fiber A after drying was 0.03 g/m², and then dried to obtain a partition member for a total heat exchange element.

### Example 1-2

A partition member for a total heat exchange element was obtained in the same manner as in Example 1-1, except that the cellulose fine fiber A was coated and dried such that an adhesion amount (coating amount) after drying was 0.08 g/m².

### Comparative Example 1-1

The substrate A was used as is as a partition member for the total heat exchange element.

### Comparative Example 1-2

A partition member for a total heat exchange element was obtained in the same manner as in Example 1-1, except that the cellulose fine fiber A was coated and dried such that an adhesion amount (coating amount) after drying was 0.02 g/m².

### Example 1-3

A partition member for a total heat exchange element of Example 1-3 was obtained in the same manner as in Example 1-1, except that the following procedures were performed.

### “Producing Partition Member for Total Heat Exchange Element”

A coating solution was prepared by adding 0.8 parts of a polyether surfactant (product name: SN Wet 985, manufactured by San Nopco, 76% aqueous dispersion) to 99.2 parts of the 0.4% aqueous dispersion of the cellulose fine fiber A obtained above.

The coating solution was coated to one side of the substrate A using a Mayer bar such that an adhesion amount of the cellulose fine fiber A after drying was 0.17 g/m², and then dried to obtain a partition member for a total heat exchange element.

### Example 1-4

A partition member for a total heat exchange element was obtained in the same manner as in Example 1-1, except that the substrate A was changed to the substrate B, and that the cellulose fine fiber A was coated and dried such that an adhesion amount (coating amount) after drying was 0.09 g/m².

### Comparative Example 1-3

The substrate B was used as is as a partition member for the total heat exchange element.

### Example 1-5

A partition member for a total heat exchange element was obtained in the same manner as in Example 1-1, except for the following.

### “Producing Partition Member for Total Heat Exchange Element”

A 0.4% dispersion of the cellulose fine fiber B obtained above was used as a coating solution.

After corona discharge treatment was performed on one side of the substrate A, the coating solution was coated using a Mayer bar such that an adhesion amount (coating amount) of the cellulose fine fiber B after drying was 0.28 g/m², and then dried to obtain a partition member for a total heat exchange element.

### Example 1-6

A partition member for a total heat exchange element was obtained in the same manner as in Example 1-5, except that the cellulose fine fiber B was coated and dried such that an adhesion amount (coating amount) after drying was 0.10 g/m².

### Example 1-7

A partition member for a total heat exchange element was obtained in the same manner as in Example 1-5, except that the substrate A was changed to the substrate B, and that the cellulose fine fiber B was coated and dried such that an adhesion amount (coating amount) after drying was 0.28 g/m².

### (Evaluation)

The moisture permeability and the air permeability of the partition member for a total heat exchange element obtained in the Examples and Comparative Examples were measured and are shown in Tables 1 and 2.

### “Moisture Permeability”

Measured in accordance with JIS Z0208:1976 under conditions of 20° C. and 65% RH. Calculated using the following formula:

$$Moisture permeability = ( a + b ) / 2$$

where a=mass increase one hour after the start of measurement and
   b=mass increase one hour between one hour and two hours after the start of measurement

### “Air Permeability”

Measured in accordance with the Oken air permeability method in JAPAN TAPPI Paper and Pulp Testing Method No. 5-2:2000.

### “Carbon Dioxide Gas Barrier Properties”

A 12-cm square partition member was prepared. High-concentration CO₂ was used. In addition, a measurement device including a container A, which measured the CO₂ concentration, and a container B, which was constantly ventilated with outside air, and the partition member between the container A and the container B was used. The container A was filled with 20,000 ppm of CO₂ at room temperature and pressure, and then left for 15 minutes. The CO₂ concentration inside the container A was then measured using a CO₂ analyzer. The amount of CO₂ passing through the partition member over 15 minutes was calculated as the decrease in CO₂ concentration inside the container A. When the CO₂ concentration inside the container A was 2,500 ppm or higher, the carbon dioxide gas barrier properties of the partition member were judged to be good (o), while when it was less than 2,500 ppm, they were judged to be poor (x).

The evaluation results are shown in Tables 1 and 2 below.

TABLE 1

| | | | Comparative | Comparative | |
|---|---|---|---|---|---|
| | Example 1-1 | Example 1-2 | Example 1-1 | Example 1-2 | Example 1-3 |
| Substrate | Substrate A | Substrate A | Substrate A | Substrate A | Substrate A |
| Fine fibers | Fiber A | Fiber A | | Fiber A | Fiber A |
| Surfactant | Added | Added | | Added | Added |
| Corona treatment | With | With | | With | Without |
| | processing | processing | | processing | processing |
| Coating amount | 0.03 | 0.08 | | 0.02 | 0.17 |
| (g/m²) | | | | | |
| Moisture | 3546 | 3347 | 3260 | 3754 | 2900 |
| permeability | | | | | |
| (g/m² · 24 Hr) | | | | | |
| Air permeability | 13275 | 99999 or | 169 | 870 | 99999 or |
| (seconds) | | more | | | more |
| CO₂ gas barrier | ∘ | ∘ | x | x | ∘ |
| properties | | | | | |

TABLE 2

| | | Comparative | | | |
|---|---|---|---|---|---|
| | Example 1-4 | Example 1-3 | Example 1-5 | Example 1-6 | Example 1-7 |
| Substrate | Substrate B | Substrate B | Substrate A | Substrate A | Substrate B |
| Fine fibers | Fiber A | | Fiber B | Fiber B | Fiber B |
| Surfactant | Added | | Not added | Not added | Not added |
| Corona treatment | With | | With | With | With |
| | processing | | processing | processing | processing |
| Coating amount | 0.09 | | 0.28 | 0.10 | 0.28 |
| (g/m²) | | | | | |
| Moisture | 3418 | 3600 | 2985 | 4685 | 3326 |
| permeability | | | | | |
| (g/m² · 24 Hr) | | | | | |
| Air permeability | 42468 | 305 | 99999 or | 28539 | 75395 |
| (seconds) | | | more | | |
| CO₂ gas barrier | ∘ | x | ∘ | ∘ | ∘ |
| properties | | | | | |

### Example 2-1

### “Producing Partition Member for Total Heat Exchange Element”

A coating solution was prepared by adding 0.8 parts of a polyether surfactant (product name: SN Wet 985, manufactured by San Nopco, 76% aqueous dispersion) to 99.2 parts of the 0.4% aqueous dispersion of the cellulose fine fiber A obtained above.

The coating solution was hand-coated with a Mayer bar onto one side of the substrate A such that an adhesion amount of the cellulose fine fiber A after drying was 0.12 g/m². The surface was then dried to obtain a partition member for a total heat exchange element. The areal density of the partition member was 10.29 g/m².

### Example 2-2

The substrate was prepared in the same manner as in Example 2-1, except that the substrate A was changed to the substrate B, and that the cellulose fine fiber A was hand-coated and dried such that an adhesion amount after drying was 0.25 g/m². The areal density of the partition member was 9.89 g/m².

### Example 2-3

A partition member for a total heat exchange element was obtained in the same manner as in Example 2-1, except for the following.

### “Producing Partition Member for Total Heat Exchange Element”

The 0.4% dispersion of the cellulose fine fiber B obtained above was used as a coating solution.

After corona discharge treatment was performed on one side of the substrate A, the coating solution was hand-coated using a Mayer bar such that an adhesion amount of the cellulose fine fiber after drying was 0.35 g/m², and then dried to obtain a total heat exchange element. The areal density of the partition member was 10.35 g/m².

### Comparative Example 2-1 in

A partition member for a total heat exchange element was obtained in the same manner as in Example 2-1, except that the cellulose fine fiber A was coated and dried such that an adhesion amount after drying was 0.02 g/m². The areal density of the partition member was 10.05 g/m².

### Comparative Example 2-2

The substrate A was used as is as a partition member for the total heat exchange element.

### Comparative Example 2-3

The substrate B was used as is as a partition member for the total heat exchange element.

### Example 2-4

A partition member for a total heat exchange element was obtained in the same manner as in Example 2-1, with the following exceptions.

### “Producing Partition Member for Total Heat Exchange Element”

A 0.5% aqueous dispersion of the cellulose fine fiber A obtained above was used as a coating solution.

The coating solution was coated to one side of the substrate A using a bar coater, and the substrate was dried at a dryer temperature not exceeding 70° C. to obtain a partition member for a total heat exchange element. The adhesion amount of the cellulose fine fiber A was 0.05 g/m². The areal density of the partition member was 10.05 g/m².

### Example 2-5

A partition member for a total heat exchange element was obtained in the same manner as in Example 2-1, with the following exceptions.

### “Producing Partition Member for Total Heat Exchange Element”

A coating solution was prepared by adding 0.4 parts of a polyether surfactant (product name: SN Wet 985, manufactured by San Nopco, 76% aqueous dispersion) to 99.6 parts of the 0.5% aqueous dispersion of the cellulose fine fiber A obtained above.

The coating solution was coated to one side of the substrate A using a bar coater, and the substrate was dried, ensuring the dryer temperature did not exceed 70° C., to obtain a partition member for a total heat exchange element. The adhesion amount of the cellulose fine fiber A was 0.15 g/m². The areal density of the partition member was 10.24 g/m².

### (Evaluation)

The moisture permeability and the air permeability of the partition member for a total heat exchange element obtained in the Examples and Comparative Examples were measured and are shown in Tables 3 and 4. In addition, carbon dioxide barrier properties were also evaluated for Examples 2-4 and 2-5 and Comparative Examples 2-2 and 2-3.

### “Moisture Permeability”

Measured in accordance with JIS Z0208:1976 under conditions of 20° C. and 65% RH. Calculated using the following formula:

$$Moisture permeability = ( a + b ) / 2$$

where a=mass increase one hour after the start of measurement, and
   b=mass increase one hour between one hour and two hours after the start of measurement

### “Air Permeability”

Measured in accordance with the Oken air permeability method in JAPAN TAPPI Paper and Pulp Testing Method No. 5-2:2000.

### <Carbon Dioxide Barrier Properties>

The measurement device including a carbon dioxide (CO₂) analyzer was installed inside a 1-meter-long acrylic cube with 20-cm square windows in the center of each of four side panels and one top panel.

With 25-cm square partition members affixed to each window, 5,000 ppm of carbon dioxide was sealed inside the container. The CO₂ concentration was measured four times at 15-minute intervals for a total of one hour at 20° C. and 65% humidity.

The rate of decrease in carbon dioxide concentration at each time point is calculated from the measured values after 15 minutes, 30 minutes, 45 minutes, and 60 minutes, and the average is then calculated to determine the rate of decrease in carbon dioxide concentration of the measured sample. The lower the rate of decrease in carbon dioxide concentration, the better the carbon dioxide (CO₂) barrier property of the partition member.

Note that partition members with a rate of decrease in carbon dioxide concentration of 1.3% or less are preferably used.

TABLE 3

| | | | | Comparative |
|---|---|---|---|---|
| | Example | Example | Example | Example |
| | 2-1 | 2-2 | 2-3 | 2-1 |
| Substrate | Substrate | Substrate | Substrate | Substrate |
| | A | B | A | A |
| Thickness of | 20 | 16 | 20 | 20 |
| substrate (μm) | | | | |
| Fine fibers | Fiber A | Fiber A | Fiber B | Fiber A |
| Surfactant | Added | Added | Not added | Added |
| Corona | Without | Without | With | With |
| treatment | processing | processing | processing | processing |
| Coating amount | 0.12 | 0.25 | 0.35 | 0.02 |
| (g/m²) | | | | |
| Areal density of | 10.29 | 9.89 | 10.35 | 10.05 |
| partition member | | | | |
| (g/m²) | | | | |
| Moisture | 3000 | 3000 | 3300 | 3754 |
| permeability | | | | |
| (g/m² · 24 Hr) | | | | |
| Air permeability | 99999 or | 99999 or | 99999 or | 870 |
| (seconds) | more | more | more | |

TABLE 4

| | Comparative | Comparative | | |
|---|---|---|---|---|
| | Example | Example | Example | Example |
| | 2-2 | 2-3 | 2-4 | 2-5 |
| Substrate | Substrate | Substrate | Substrate | Substrate |
| | A | B | A | A |
| Thickness of | 20 | 16 | 20 | 20 |
| substrate (μm) | | | | |
| Fine fibers | | | Fiber A | Fiber A |
| Surfactant | | | Not added | Added |
| Corona | | | Without | Without |
| treatment | | | processing | processing |
| Coating amount | | | 0.05 | 0.15 |
| (g/m²) | | | | |
| Areal density of | 10.0 | 9.4 | 10.05 | 10.24 |
| partition member | | | | |
| (g/m²) | | | | |
| Moisture | 3260 | 3600 | 3500 | 3300 |
| permeability | | | | |
| (g/m² · 24 Hr) | | | | |
| Air permeability | 169 | 305 | 61337 | 94702 |
| (seconds) | | | | |
| CO₂ gas barrier | 16.82 | 17.06 | 1.16 | 0.41 |
| properties (%) | | | | |

### EXPLANATION OF REFERENCE NUMERALS

1 partition member
2 spacing member
4 first air flow path
5 second air flow path
10 total heat exchange element

What is claimed is:

1. A partition member for a total heat exchange element comprising a hydrophobic porous substrate and a hydrophilic material,
wherein an air permeability is 10,000 seconds or more and a moisture permeability under conditions of 20° C. and 65% RH is 2,500 g/m²·24 hours or more.

2. A partition member for a total heat exchange element comprising a hydrophobic porous substrate and polymer polysaccharide fine fibers with a fiber width of 1 to 1,000 nm at least in pores of the hydrophobic porous substrate, and having an air permeability of 10,000 seconds or more and a moisture permeability under conditions of 20° C. and 65% RH of 2,500 g/m²·24 hours or more.

3. The partition member for a total heat exchange element according to claim 2, wherein the fine fiber is cellulose fine fiber.

1. The partition member for a total heat exchange element according to claim 2, wherein an air permeability of the hydrophobic porous substrate is 1,000 seconds or less.

5. The partition member for a total heat exchange element according to claim 4, wherein a thickness of the hydrophobic porous substrate is 5 μm or more and 30 μm or less.

6. The partition member for a total heat exchange element according to claim 1, wherein the fine fibers are adhered to the hydrophobic porous substrate.

7. A partition member for a total heat exchange element comprising a hydrophobic porous substrate and a hydrophilic material,
wherein the hydrophilic material is adhered to the hydrophobic porous substrate,
a thickness of the hydrophobic porous substrate is 5 μm or more and 30 μm or less,
an adhesion amount of the hydrophilic material is 0.01 g/m² or more and 8 g/m² or less, and
the partition member for a total heat exchange element has an areal density of 30 g/m² or less and an air permeability of 10,000 seconds or more.

8. A total heat exchange element comprising a plurality of the partition members for a total heat exchange element according to claim 1,
wherein the total heat exchange element has a first air flow path formed by the partition member for a total heat exchange element and a spacing member provided thereon, and a second air flow path formed by the partition member for a total heat exchange element that forms the first air flow path and the spacing member provided below the partition member for a total heat exchange element that forms the first air flow path.

9. A method for producing a partition member for a total heat exchange element, wherein the method includes coating a coating solution containing polymer polysaccharide fine fibers with a fiber width of 1 to 1,000 nm to a hydrophobic porous substrate and then drying.

10. The method for producing a partition member for a total heat exchange element according to claim 9, wherein the coating solution contains a surfactant.

11. The method for producing a partition member for a total heat exchange element according to claim 9, wherein a coating amount of the fine fiber is 0.01 g/m² or more and 8 g/m² or less.

12. The method for producing a partition member for a total heat exchange element according to claim 9, wherein the fine fiber is cellulose fine fiber.

13. The method for producing a partition member for a total heat exchange element according to claim 9, wherein an air permeability of the hydrophobic porous substrate is 1,000 seconds or less.

14. The method for producing a partition member for a total heat exchange element according to claim 9, wherein the hydrophobic porous substrate is subjected to surface hydrophilization treatment and then coated with the coating solution.

15. A method for producing a partition member for a total heat exchange element having an areal density of 30 g/m² or less and an air permeability of 10,000 seconds or more, comprising coating a coating solution containing a hydrophilic material to at least one surface of a hydrophobic porous substrate having a thickness of 5 μm or more and 30 μm or less, so that an amount of the hydrophilic material adhered is 0.01 g/m² or more and 8 g/m² or less, and drying the coating solution.

16. A total heat exchange element comprising a plurality of the partition members for a total heat exchange element according to claim 2, wherein the total heat exchange element has a first air flow path formed by the partition member for a total heat exchange element and a spacing member provided thereon, and a second air flow path formed by the partition member for a total heat exchange element that forms the first air flow path and the spacing member provided below the partition member for a total heat exchange element that forms the first air flow path.

17. A total heat exchange element comprising a plurality of the partition members for a total heat exchange element according to claim 7,
wherein the total heat exchange element has a first air flow path formed by the partition member for a total heat exchange element and a spacing member provided thereon, and a second air flow path formed by the partition member for a total heat exchange element that forms the first air flow path and the spacing member provided below the partition member for a total heat exchange element that forms the first air flow path.
